(19) United States
(12) Patent Application Publication
(10) Pub. No.: US 2022/0261640 A1
(43) Pub. Date: Aug. 18, 2022

(54) IMPLEMENTING MACHINE LEARNING IN A RESOURCE-CONSTRAINED ENVIRONMENT

(71) Applicant: University of Surrey, Guildford, Surrey (GB)

(72) Inventors: Sotiris MOSCHOYIANNIS, Guildford, Surrey (GB); Angelos CHRISTIDIS, Guildford, Surrey (GB)

(21) Appl. No.: 17/625,635

(22) PCT Filed: Jul. 10, 2020
(86) PCT No.: PCT/GB2020/051672

§ 371 Date: Jan. 7, 2022

(30) Foreign Application Priority Data
Jul. 11, 2019 (GB) 1909991.0

(51) Int. Cl. G06N 3/08

(52) U.S. Cl. CPC G06N 3/08

(57) ABSTRACT

A computer-implemented method includes loading the contents of a package including a computer program into an encapsulated execution and executing, by one or more computing devices, the computer program in the encapsulated execution environment. A data storage size of the contents of the package is constrained from exceeding a package data storage size limit. The execution of the computer program causes processing. The processing includes obtaining, from a cloud storage service, a trained machine learning model; loading, in to temporary storage of the encapsulated execution environment, the trained machine learning model; and applying the trained machine learning model to derive one or more vector outputs based on one or more vector inputs. The combined data storage size of the trained machine learning model and the contents of the package exceeds the package data storage size limit.

### FIELD OF THE INVENTION

This specification relates to the implementation of machine learning in a resource-constrained environment.

### BACKGROUND

Machine learning models are being used to perform an increasingly wider range of computational tasks. Machine learning models often produce better results than alternative methods and may enable the performance of otherwise unperformable tasks. However, computer programs utilizing machine learning models often consume more memory, storage and computational resources than other computer programs. This may be problematic in environments where memory, storage space and computational resources are constrained, e.g. serverless computing environments.

### SUMMARY

According to one aspect, a computer-implemented method is provided. The method comprises loading the contents of a package comprising a computer program into an encapsulated execution environment; and executing, by one or more computing devices, the computer program in the encapsulated execution environment. The data storage size of the contents of the package may be constrained from exceeding a package data storage size limit. Executing the computer program may cause processing comprising obtaining, from a cloud storage service, a trained machine learning model; loading, in to temporary storage of the encapsulated execution environment, the trained machine learning model; and applying the trained machine learning model to derive one or more vector outputs based on one or more vector inputs. The combined data storage size of the trained machine learning model and the contents of the package exceeds the package data storage size limit

The encapsulated execution environment may be a container.

The encapsulated execution environment may be a virtual machine.

Applying the trained machine learning model may further comprise obtaining the one or more vector inputs by querying a non-relational database; and processing, with the trained machine learning model, the one or more vector inputs to derive the one or more vector outputs

The non-relational database may partition data entries across a plurality of database partitions using a partition key. The partition key may be an entity identifier.

Querying the non-relational database may utilise a sort key based on incrementing integer timestamps. The incrementing integer timestamps are Unix timestamps.

The trained machine learning model may comprise a representation of one or more computational graphs in a neural network exchange format.

The trained machine learning model may have been trained using a first machine learning framework and may be applied using a second machine learning framework. The data storage size of the first machine learning framework may be greater than a data storage size of the second machine learning framework. The first machine learning framework may be a development machine learning framework. The second machine learning framework may be a production machine learning framework.

The contents of the package may comprise a slimmed down machine learning framework. Applying the trained machine learning model may use the slimmed down machine learning framework.

The slimmed down machine learning framework may comprise a subset of a plurality of files of a full machine learning framework. The subset may exclude one or more of the plurality of files that are not accessed during one or more applications of the trained machine learning model using the full machine learning framework.

According to another aspect a data processing system is provided. The data processing system configured to carry out a method according to any preceding definition

According to another aspect a package is provided. The package may comprise a computer program. The data storage size of the package may be constrained from exceeding a package data storage size limit. The computer program may comprise instructions, which, when executed in an encapsulated execution environment by one or more computing devices, may cause the one or more computing devices to carry out obtaining, from a cloud storage service, a trained machine learning model; loading, in to temporary storage of the encapsulated execution environment, the trained machine learning model; and applying the trained machine learning model to derive one or more vector outputs based on one or more vector inputs. The combined data storage size of the trained machine learning model and the contents of the package may exceed the package data storage size limit.

According to another aspect, a computer-readable storage medium is provided, the computer-readable storage medium having stored thereon a package according to any preceding definition.

### BRIEF DESCRIPTION OF THE DRAWINGS

Certain embodiments of the invention will now be described, by way of example, with reference to the following figures.

FIG. 1 is a schematic block diagram illustrating an example of a system where a trained machine learning model may be utilized;

FIG. 2 is a flow diagram of an example method for applying a trained machine learning model;

FIG. 3 is a flow diagram of an example method for loading and executing a computer program in an encapsulated execution environment;

FIG. 4 is a flow diagram of an example method for running a machine learning model on a different machine learning framework to the machine learning framework on which it is trained; and

FIG. 5 is flow diagram of an example method for deriving a slimmed down machine learning framework.

### DETAILED DESCRIPTION

Example implementations provide systems and methods for utilizing machine learning models in resource constrained environments.

### Computer System

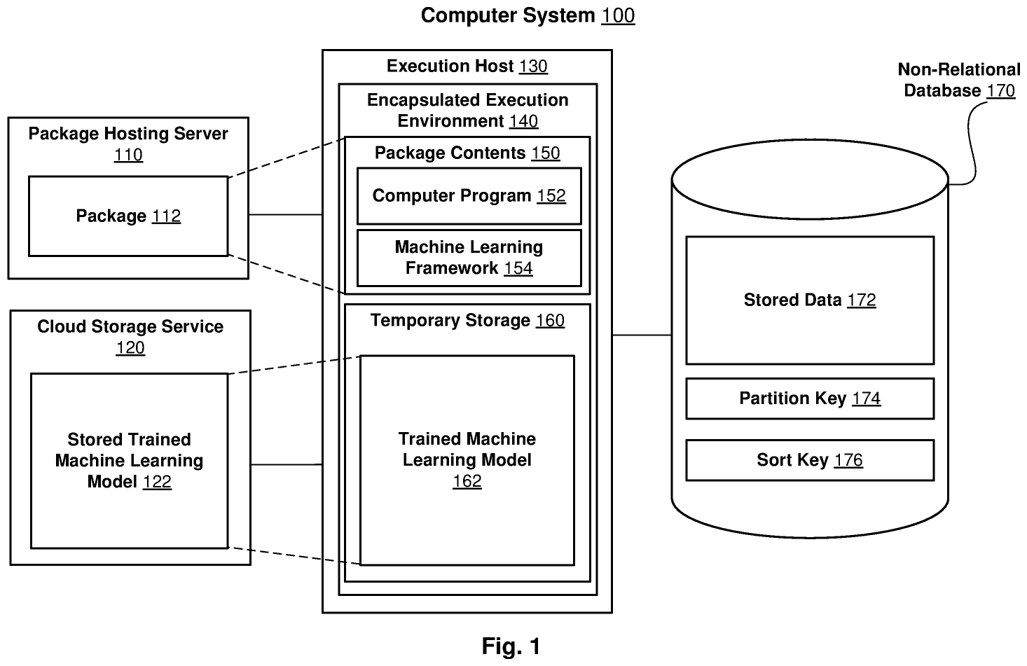

FIG. 1 is a schematic block diagram illustrating an example of a computer system 100 where a trained machine learning model may be utilized.

The computer system 100 includes a package hosting server 110, a cloud storage service 120, an execution host 130 and a non-relational database 170. Each of the package hosting server 100, the cloud storage service 120 and the non-relational database 170 are configured to communicate with the execution host 130 over respective networks. Each of the respective networks may be the same network or a different network. Each of the respective networks may be any of or any combination of a local area network, the Internet, a private wide area network (WAN), a virtual private network (VPN) and/or an internal network of a cloud computing service. For the purpose of clarity, some functional aspects of the computer system 100 are each discussed as relating to a computing device. Any of these functional aspects may be collocated on a single computing device, e.g. the package deployment server 110 may be collocated on the same device as the execution host 130. Alternatively or additionally, any of these functional aspects may be distributed across a number of computing devices. For example, the cloud storage service 120 may be a distributed cloud storage service hosted across a plurality of computing devices and/or the non-relational database 170 may be a distributed non-relational database 170 hosted across a plurality of computing devices.

The package hosting server 110 can be any suitable computing device or may be a server of a cloud storage service. For example, the package hosting server 110 may be a commodity server, a rack server, a desktop computer, a mainframe, a laptop computer or one or more servers of a cloud storage service. The package hosting server 110 may store packages using any suitable technology. For example, the packages may be stored as files, binary database entries or as binary large objects (BLOBs). The package hosting server 110 may provide the packages to other devices in the network using any suitable technology. For example, the packages may be provided to other devices using a database host service or a file host service. Where the package hosting server 110 is one or more servers of a cloud storage service, the package hosting server 110 may, for example, be one or more servers of Amazon Simple Storage Service (Amazon S3), Azure Storage, or another cloud storage service. This cloud storage service may be the cloud storage service 120 or may be a different cloud storage service.

The package hosting server 110 hosts a package 112 which includes package contents 150, which will be described later. The package 112 may be a compressed archive including the package contents 150. For example, the package 112 may be a ZIP file, a JAR file, a tape archive file compressed using gzip (a tar.gz file), a tape archive file compressed using bzip2 (a tar.bz2 file) or a 7z file. Alternatively, the package 112 may be in an uncompressed form, e.g. as a conventional folder on the file system of the package hosting server no.

The cloud storage service 120 provides data storage accessible over a network by computing devices. In the cloud storage service 120, digital data may be stored in and retrieved from logical data pools. The physical storage devices, e.g. hard disk drives and solid state drives, providing the data storage may be distributed across multiple servers and, in some instances, across multiple locations. Using data storage distributed across multiple servers may facilitate the storage being highly redundant, available, scalable, and fast to access in comparison to data storage hosted on a single server. The cloud storage service may be an object storage service, a block storage service, a file storage service, or a cloud database. The cloud storage service may be a commercial cloud storage service provided by a cloud storage provider. For example, the cloud storage service may be Amazon Simple Storage Service (Amazon S3), Azure Storage, or another cloud storage service. The cloud storage service may also be a cloud storage service hosted within a private cloud, e.g. as part of a private cloud implemented using an OpenStack platform. Examples of cloud storage service software that may be used to provide a cloud storage service using a private cloud include Swift, Cinder and Manila, which provide object, block and file storage respectively.

The cloud storage service 120 stores a stored trained machine learning model 122. The stored trained machine learning model 122 may be stored as part of a compressed file or a compressed archive. For example, the stored trained machine learning model 122 may be stored as a ZIP file, a tape archive file compressed using gzip (a tar.gz file), a tape archive file compressed using bzip2 (a tar.bz2 file) or a 7z file. Alternatively, the stored trained machine learning model 122 may be stored uncompressed or in a machine learning model compression format. The stored trained machine learning model 122 may be represented in a neural network exchange format. The neural network exchange format may represent the machine learning model as a computational graph. The neural network exchange format may be a format for representing neural networks that is compatible with several neural network frameworks. Examples of neural network exchange formats are the Open Neural Network eXchange format (ONNX) and the Neural Network Exchange Format (NNEF). Alternatively, the stored trained machine learning model 122 may be represented in a machine-learning-framework-specific format.

The execution host 130 can be any suitable computing device. For example, the execution host 130 may be a commodity server, a rack server, a desktop computer, a mainframe or a laptop computer. The execution host 130 may be distributed across multiple computing devices, e.g. across multiple commodity servers and/or rack servers. The execution host 130 may be an execution host of a cloud computing service providing a serverless computing service. The serverless computing service may provide Functions as a Service (FaaS). FaaS facilitates the execution of code without provisioning or managing servers. With FaaS, code may be run in response to events or requests as ‘functions’, the servers and environments used to execute the code are then automatically provisioned by the serverless computing platform. Examples of serverless computing services providing FaaS include AWS Lambda, Azure Functions, and IBM cloud functions. Serverless computing services providing FaaS may also be hosted within a private cloud using serverless computing service software. Examples of serverless computing service software providing FaaS include Apache OpenWhisk, Kubeless and OpenFaaS.

The execution host 130 provides an encapsulated execution environment 140. The encapsulated execution environment 140 isolates, at least to a limited degree, the processing being performed and data stored within the encapsulated execution environment from other processing and data stored within the execution host. Multiple encapsulated execution environments may be provided by the execution host 130. The isolation provided by each of these encapsulated execution environments facilitates running multiple programs, processes, functions or platforms on the execution host 130 while minimising interference between them and maintaining security and privacy requirements. For example, the isolation provided by each encapsulated execution environment may facilitate functions from multiple organizations being executed on the execution host 130 without compromising their security and/or privacy.

The encapsulated execution environment 140 may be a virtual machine. The virtual machine emulates a computer system. A guest operating system is hosted on the virtual machine and the virtual machine appears to the guest operating system to be akin to a physical machine. The virtual machine may be provided using a hypervisor, i.e. a virtual machine monitor. The hypervisor may be integrated with a host operating system of the execution host 130. For example, the Kernel-based Virtual Machine (KVM) hypervisor is built into the Linux kernel and the Hyper-V hypervisor is built into Windows Server. The hypervisor may also facilitate hardware-assisted virtualization to improve the performance of the virtual machine. Hardware-assisted virtualization may utilize processor virtualization instructions, e.g. Intel VT-x on Intel processors and AMD-V on AMD processors. The virtual machine may be a microVM. An example of a hypervisor providing microVMs is Firecracker, which is used by AWS Lambda. MicroVMs may start faster and use less computational resources than other VMs.

The encapsulated execution environment 140 may be a container. The container isolates the execution environment of applications running within the container from those executed directly on the execution host 130 or in other containers. The container uses the operating system kernel and hardware of the execution host 130 and shares these with applications running directly on the execution host or in other containers. To achieve isolation, the container presents the underlying resources, provided by the kernel and hardware, to make them appear to applications within the container that they are dedicated to the container. The container may also restrict access to various system resources of the execution host 130, e.g. the file system, to raw devices by applications running within the container. The container may also throttle the amount of computational resources, e.g. CPU, memory and persistent storage, which applications running within the container may access. A container may be smaller than a comparable virtual machine as they use the operating system kernel of the execution host 130.

Advantages of using a virtual machine over a container include hardware-virtualization-based security and better workload isolation. Advantages of using a container over a virtual machine include fast start-up times; better resource utilization, and high density, i.e. more containers may fit on a single execution host.

Package contents 150 of the package 112 may be loaded in to the encapsulated execution environment 140. Where the package 112 is stored as a compressed archive, loading the package contents 150 may include decompressing the package. The data storage size of the package contents 150 may be constrained from exceeding a package data storage size limit. The data storage size of the package contents 150 may be constrained by the encapsulated execution environment or by a cloud computing service of which the execution host 130 is a part. The loading of the package contents 150 into the encapsulated execution environment 140 may be performed by the execution host 130, the package hosting server no or by another device of a cloud computing service of which the execution host 130 is a part.

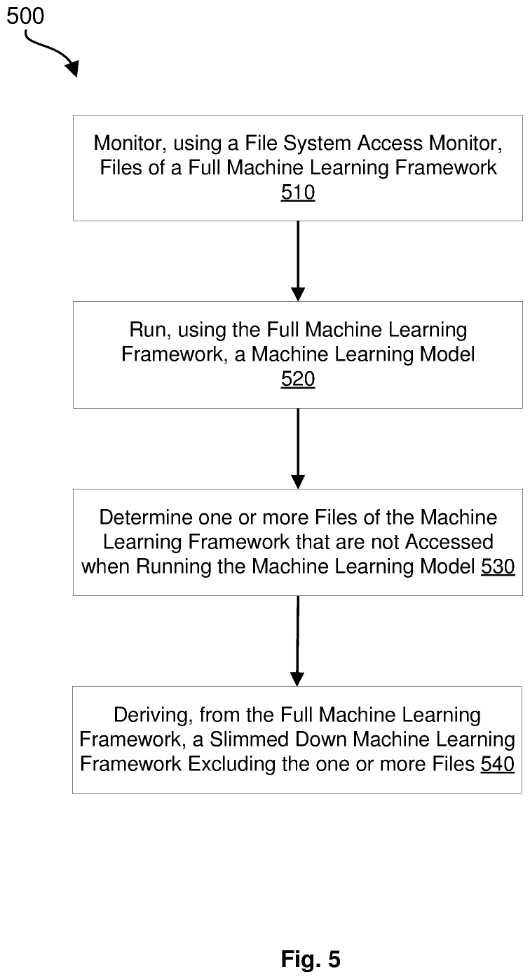

The package contents 150 include a computer program 152 and a machine learning framework 154. The computer program 152 may be a ‘function’ to be executed by a serverless computing service providing FaaS with the execution host 130 being part of the serverless computing service. The serverless computing service may limit the time each ‘function’ may run for. The time that the computer program 152, and processing caused thereby, may run for may be constrained by the time limit. The machine learning framework 154 may be used by the computer program 152. The machine learning framework 154 may be any suitable machine learning framework, e.g. PyTorch, ONNX Runtime, Caffe2, TensorFlow or MxNet. The machine learning framework may be a full machine learning framework or may be a slimmed down machine learning framework. A slimmed down machine learning framework includes a subset of the files of a full machine learning framework, e.g. PyTorch. For example, the subset may not include those files that are not accessed when the trained machine learning model 162 is executed. A method 500 for deriving a slimmed down machine learning framework is described with respect to FIG. 5.

The encapsulated execution environment may also include temporary storage 160. The temporary storage may be a temporary directory, e.g. a ‘/tmp’ directory, or a disk partition used for storing data temporarily. The temporary storage 160 may be persistent storage rather than volatile storage, e.g. disk storage rather than memory. The capacity of the temporary storage 160 may be greater than the package data storage size limit. A trained machine learning model 162 may be stored in the temporary storage 160, e.g. by the computer program 152.

The computer program 152 may be executed on the execution host 130 within the encapsulated execution environment 140. Executing the computer program may cause a trained machine learning model 162 to be obtained from the cloud storage service 120. The trained machine learning model 162 may be obtained by retrieving the stored trained machine learning model 122 from the cloud storage service 120, and where the stored trained machine learning model 122 is stored as a compressed archive or file, decompressing the stored trained machine learning model 122 to obtain the trained machine learning model 162. The trained machine learning model 162 may be represented in a neural network exchange format. The neural network exchange format may be a format for representing neural networks that is compatible with several neural network frameworks. Examples of neural network exchange formats are the Open Neural Network eXchange format (ONNX) and the Neural Network Exchange Format (NNEF). Alternatively, the trained machine learning model 162 may be represented in a machine-learning-framework-specific format.

The computer program 152 may cause the trained machine learning model 162 to be loaded in the temporary storage 160. While the temporary storage 160 may have the capacity to store the trained machine learning model 162, the data storage size of the trained machine learning model 162, and, in some cases, the size of the stored trained machine learning model 122 may exceed the package data storage size limit. In other cases, the data storage size of trained machine learning model 162 and/or the stored trained machine learning model 122 may not exceed the package data storage size limit but their data storage size in combination with that of the package contents 150 would exceed the package data storage size limit.

The computer program may cause the trained machine learning model 162 to be applied, i.e. run or executed. The trained machine learning model may be applied using the machine learning framework 154. The trained machine learning model 162 may have been trained using a different machine learning framework to the machine learning framework 154, i.e. the trained machine learning model may have been trained using a different machine learning framework to that on which it is run. The different machine learning framework may have a greater data storage size than the machine learning framework 154. The application of the trained machine learning model 162 using the machine learning framework 154 rather than that with which it was trained may be facilitated by the use of a neural network exchange format for the trained machine learning model 162.

The machine learning framework 154 may be a production machine learning framework, i.e. a machine learning framework adapted for the execution of machine learning models, while the different machine learning framework may be a development machine learning framework, i.e. a machine learning framework adapted for the training of machine learning models. A production machine learning framework may use less computational resources, e.g. CPU, GPU and/or memory, than a development machine learning framework. In the art, some production machine learning frameworks may be referred to as ‘machine learning runtimes’. The term ‘production machine learning framework’ should be interpreted as including such ‘machine learning runtimes’. A development machine learning framework may provide functionality facilitating training, e.g. debugging functionality and optimization functions, and may provide a variety of additional functionality which is unused by the trained machine learning model 162 in production but would be useful for experimentation during training.

Applying the trained machine learning model may cause one or more vector outputs to be derived based on one or more vector inputs. The one or more vector inputs may be obtained by querying the non-relational database 170. The one or more vector inputs may be the one or more vectors which are returned by the non-relational database 170 in response to the query. The trained machine learning model 162 may process the one or more vector inputs to derive the one or more vector outputs.

The non-relational database 170 may be any suitable non-relational database. The non-relational database may be a NoSQL database. Examples of types of non-relational databases include key-value stores, document-oriented databases and columnar databases. The non-relational database 170 may be a non-relational database provided as a cloud service or may be a non-relational database served using specified software and hosted on one or more local computing devices or one or more computing devices (and/or virtual machines) provided by a cloud computing provider. Examples of non-relational databases provided as a cloud service include Amazon DynamoDB, Amazon Redshift, Amazon DocumentDB, and Azure Cosmos DB. Examples of non-relational databases served using specified software include Apache Cassandra, CouchDB and MongoDB. Using a non-relational database instead of a relational database may have the advantage of reducing the time to query data. The queried data may be used as one or more vector inputs to the trained machine learning model 162. Where the execution host 130 is an execution host of a cloud computing service providing a serverless computing service, the time in which the computer program 152 and processing caused thereby may run for may be limited. The reduced time in which a non-relational database queries data may facilitate the use of a trained machine learning model 162 using one or more vector inputs based on the queried data within such time limits.

The non-relational database 170 includes stored data 172 which is partitioned using a partition key 174 and ordered using a sort key 176. The stored data 172 of the non-relational database 170 may be distributed across multiple partitions of the database based on the partition key 174. Using an appropriate partition key 174 may facilitate the prevention of bottlenecks and throttling by spreading read/write loads across partitions. For example, the partition key 174 may be an entity identifier and, by hashing the partition key 174, these entities may be appropriately distributed across the partitions such that read/write loads are appropriately spread across these partitions. The sort key 176 may be used to index the stored data 172. The sort key 176 may also be used to order the stored data 172. Indexing the stored data 172 using the sort key 176 may facilitate fast querying of data entries using the sort key and may also facilitate fast access to groups of entries with similar sort keys. For example, data entries which relate to events occurring for a given entity may often be queried using the time at which said events occurred. Data entries relating to events occurring at similar times may also often be accessed together. Using an incrementing integer timestamp as the sort key 176 may facilitate fast querying of events using the time and may facilitate fast access to groups of entries for events occurring at similar times. An example of an incrementing integer timestamp is a Unix timestamp. Unix timestamps are also referred to as POSIX timestamps and Unix Epoch time. The Unix timestamp describes a point in time using the number of seconds, excluding leap seconds, that have elapsed at that point in time since 00:00:00 1 Jan. 1970.

### Trained Machine Learning Model Application Method

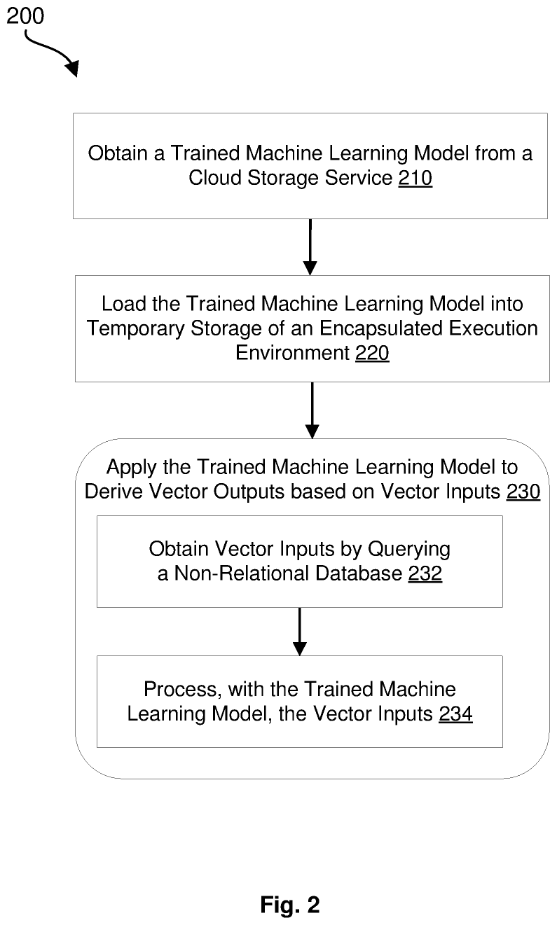

FIG. 2 is a flow diagram illustrating an example method 200 for applying a trained machine learning model. The method 200 may be performed by executing computer-readable instructions using one or more processors of one or more computing devices. For example, the method may be performed by one or more execution hosts of a cloud computing service providing a serverless computing service. The serverless computing service may provide Functions as a Service and the method 200 may be performed as a ‘function’.

In step 210, a trained machine learning model is obtained from a cloud storage service. Where the trained machine learning model is stored as a compressed archive or file using the cloud storage service, obtaining the trained machine learning model may include decompressing the archive or file. The trained machine learning model may be represented in a neural network exchange format. The neural network exchange format may be a format for representing neural networks that is compatible with several neural network frameworks. Examples of neural network exchange formats are the Open Neural Network eXchange format (ONNX) and the Neural Network Exchange Format (NNEF). Alternatively, the trained machine learning model may be represented in a machine-learning-framework-specific format.

In step 220, the trained machine learning model is loaded into temporary storage of an encapsulated execution environment. While the temporary storage may have the capacity to store the trained machine learning model, the data storage size of the trained machine learning model may exceed a package data storage size limit. The package data storage size limit constrains the data storage size of the contents of a package, where the package includes a computer program which causes the present method to be performed. In other cases, the data storage size of trained machine learning model may not exceed the package data storage size limit but their data storage size in combination with that of the package contents 150 would exceed the package data storage size limit. The temporary storage into which the trained machine learning model is loaded may be a temporary directory, e.g. a ‘/tmp’ directory, or a disk partition used for storing data temporarily. The temporary storage may be persistent storage rather than volatile storage, e.g. disk storage rather than memory.

In step 230, the trained machine learning model may be applied to derive one or more vector outputs based on one or more vector inputs. Applying the trained machine learning model may also be referred to as running or executing the trained machine learning model. The trained machine learning model may be applied using a machine learning framework, e.g. PyTorch, the ONNX Runtime, Caffe2, TensorFlow or MxNet. The trained machine learning model may be applied using a machine learning framework different to that on which it was trained. The machine learning framework used to apply the trained machine learning model may be a full machine learning framework or may be a slimmed down machine learning framework. A method 500 for deriving a slimmed down machine learning framework is described with respect to FIG. 5. Step 230 may include sub-step 232 and sub-step 234.

In sub-step 232, the one or more vector inputs may be obtained by querying a non-relational database. The queried non-relational database may be any suitable non-relational database. Non-relational databases, or at least some types of them, are also referred to as NoSQL databases. Examples of types of non-relational databases include key-value stores, document-oriented databases and columnar databases. The queried non-relational database 170 may be a non-relational database provided as a cloud service or may be a non-relational database served using specified software and hosted on one or more local computing devices or one or more computing devices (and/or virtual machines) provided by a cloud computing provider. Examples of non-relational databases provided as a cloud service include Amazon DynamoDB, Amazon Redshift, Amazon DocumentDB, Azure Cosmos DB and Amazon Document DB. Examples of non-relational databases served using specified software include Apache Cassandra, CouchDB and MongoDB. Using a non-relational database instead of a relational database may have the advantage of reducing the time to query data. Reductions in query time may be facilitated or enhanced by using appropriate partition keys and/or sort keys as is described with respect to non-relational database 160. Reductions in query time may reduce the time used to perform the method 200. The reduction in time used to perform the method 200 may facilitate the performance of the method 200 as a FaaS ‘function’ by an execution host of a serverless computing service.

In sub-step 234, the one or more vector inputs are processed, with the trained machine learning model, to derive the one or more vector outputs. Processing the one or more vector inputs with the trained machine learning model may include inputting the one or more vector inputs to the machine learning model. Where the trained machine learning model is or includes a neural network, the one or more vector inputs may then be processed using one or more neural network layers of the trained machine learning model to derive the one or more vector outputs. The one or more vector outputs may be the outputs of the trained machine learning model for the one or more vector inputs.

### Loading and Execution Method

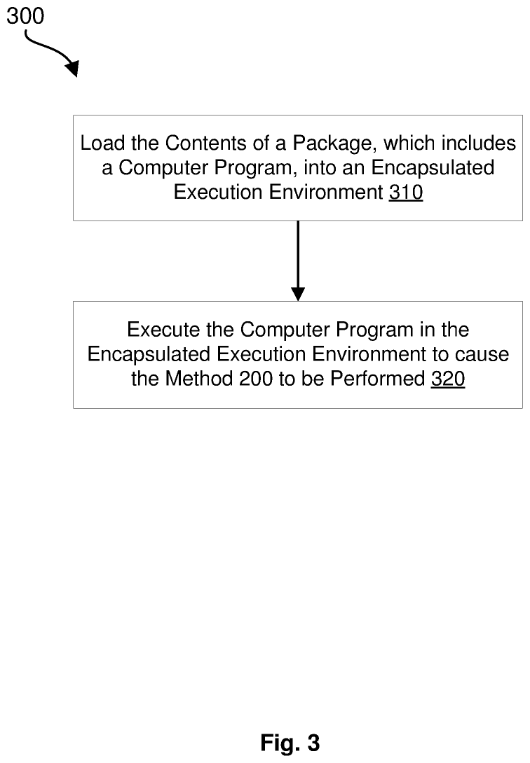

FIG. 3 is a flow diagram illustrating an example method 300 for loading and executing a computer program in an encapsulated execution environment. The method 300 may be performed by executing computer-readable instructions using one or more processors of one or more computing devices. For example, the method 300 may be performed by one or more computing devices of a cloud computing service providing a serverless computing service.

In step 310, the contents of a package, including a computer program, is loaded into an encapsulated execution environment. The data storage size of the contents of the package is constrained from exceeding a package data storage size limit. Where the encapsulated execution environment is part of a cloud computing service, the cloud computing service may determine the package data storage size limit. Where the package is a compressed archive, loading the package contents may include decompressing the package.

In step 320, the computer program, included in the contents of the package, is executed. When executed, the computer program causes the method 200 to be performed in the encapsulated execution environment.

### Machine Learning Model Framework Transfer Method

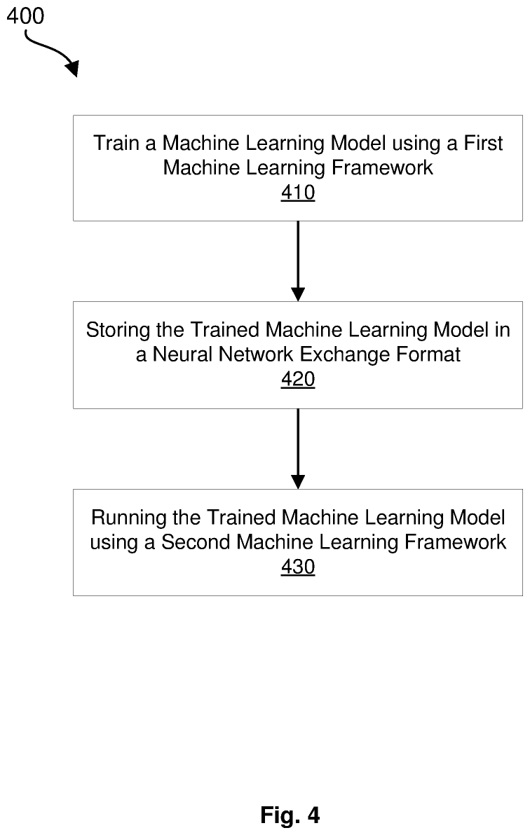

FIG. 4 is a flow diagram illustrating an example method 400 for running a machine learning model on a different machine learning framework to the machine learning framework on which it is trained. The method 400 may be performed by executing computer-readable instructions using one or more processors of one or more computing devices.

In step 410, a machine learning model is trained using a first machine learning framework. The machine learning model may be trained using training data. The training data may include a plurality of training data pairs, where each training data pair includes one or more vector inputs and an expected vector output for the one or more vector inputs. The machine learning model may be trained using the training data by, for each training data pair, processing the one or more vector inputs of the training data pair using the machine learning model to derive a vector output, calculating a loss based on the difference between the vector output and the expected vector output included in the machine learning and updating parameters of the machine learning model based on the loss in order to minimize the loss. The loss may be any suitable loss measure, e.g. mean squared error or cross-entropy loss. Where the machine learning model is a neural network, the parameters being updated may be weights of the neural network. The updates to the parameters may be calculated using gradient descent with the gradients calculated using backpropagation. The first machine learning framework may be a development machine learning framework, i.e. a machine learning framework adapted for the training of machine learning models. A development machine learning framework may provide functionality facilitating training, e.g. debugging functionality and optimization functions, and may provide a variety of additional functionality which is unused in production, i.e. when executing the machine learning model after training, but would be useful for experimentation during training. Examples of machine learning frameworks that may be used as development machine learning frameworks include PyTorch, MxNet and Tensorflow. On completion of training, the machine learning model is considered to be a trained machine learning model.

In step 420, the trained machine learning model is stored in a neural network exchange format. The neural network exchange format may represent the machine learning model as a computational graph. The neural network exchange format may be a format for representing neural networks that is compatible with several neural network frameworks. Examples of neural network exchange formats are the Open Neural Network eXchange format (ONNX) and the Neural Network Exchange Format (NNEF). The first machine learning framework may natively support storing or exporting the trained machine learning model in a neural network exchange format. Where the trained machine learning model framework does not natively support storing or exporting the trained machine learning model in a neural network exchange format, the trained machine learning model may be stored in a neural network exchange format by using a converter to convert the trained machine learning model into a neural network exchange format.

In step 430, the trained machine learning model is run using a second machine learning framework. The second machine learning framework may natively support running machine learning models stored in a neural network exchange format. Alternatively, the trained machine learning model may be run using the second machine learning framework by using a converter to convert the trained machine learning model in the neural network exchange format to a representation of the trained machine learning model supported by the second machine learning framework; and running the trained machine learning model on the second machine learning framework using this representation. The second machine learning framework may be a production machine learning framework. A production machine learning framework may use less computational resources, e.g. CPU, GPU and/or memory, than a development machine learning framework. Examples of production machine learning frameworks include the ONNX Runtime and Caffe2. In the art, some production machine learning frameworks may be referred to as ‘machine learning runtimes’. The terms ‘second machine learning framework’ and ‘production machine learning framework’ should be interpreted as including such ‘machine learning runtimes’.

### Machine Learning Framework Slimming Method

FIG. 5 is a flow diagram illustrating an example method 500 for deriving a slimmed down machine learning model. The method 500 may be performed by executing computer-readable instructions using one or more processors of one or more computing devices.

In step 510, the files of a full machine learning framework are monitored using a file system access monitor. The full machine learning framework may be any suitable machine learning framework, e.g. PyTorch, TensorFlow or the ONNX Runtime. The files of the machine learning framework may include compiled software libraries, textual computer program code, documentation, and/or data resources. Examples of suitable file system access monitors include fswatch and filemon.

In step 520, a machine learning model, e.g. the trained machine learning model utilized in the systems and methods described herein, is run using the full machine learning framework. During the running of the machine learning model, the monitoring of the files of the machine learning framework, begun in step 510, is continuing. Therefore, accesses to files of the full machine learning framework are monitored while the machine learning model is run.

In step 530, one or more files of the machine learning framework that are not accessed when running the machine learning model are determined. The files that are not accessed may be determined based on the monitoring of the files of the full machine learning framework using the file system access monitor. The file system access monitor may list or otherwise provide the files accessed when running the machine learning model. The files of the full machine learning framework may then be compared with the list of files provided by the file system access monitor. The files of the full machine learning framework which are not included in the list of accessed files may be determined to be the one or more files which are not accessed.

In step 540, a slimmed down machine learning framework is derived from the full machine learning framework. The slimmed down machine learning framework may exclude all or some of the one or more files which were not accessed. The slimmed down machine learning framework may be derived by deleting all or some of the one or more files which were not accessed from the full machine learning framework. The slimmed down machine learning framework may also be derived by copying or packaging the files of the full machine learning framework except for some or all of the one or more files which were not accessed.

### Modifications

It will be appreciated that various modifications may be made to the embodiments hereinbefore described. Such modifications may involve equivalent and other features which are already known in the fields of machine learning and/or cloud computing, e.g. in the field of serverless computing service providing FaaS, and which may be used instead of or in addition to features already described herein. Features of one embodiment may be replaced or supplemented by features of another embodiment.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A computer-implemented method comprising:
loading the contents of a package comprising a computer program into an encapsulated execution environment, wherein a data storage size of the contents of the package is constrained from exceeding a package data storage size limit; and
executing, by one or more computing devices, the computer program in the encapsulated execution environment, wherein executing the computer program causes processing comprising:
obtaining, from a cloud storage service, a trained machine learning model, wherein a combined data storage size of the trained machine learning model and the contents of the package exceeds the package data storage size limit;
loading, in to temporary storage of the encapsulated execution environment, the trained machine learning model; and
applying the trained machine learning model to derive one or more vector outputs based on one or more vector inputs.

2. The method of claim 1, wherein the encapsulated execution environment is a container.

3. The method of claim 1, wherein the encapsulated execution environment is a virtual machine.

4. The method of claim 1, wherein applying the trained machine learning model comprises:
obtaining the one or more vector inputs by querying a non-relational database; and
processing, with the trained machine learning model, the one or more vector inputs to derive the one or more vector outputs.

5. The method of claim 4, wherein the non-relational database partitions data entries across a plurality of database partitions using a partition key, wherein the partition key is an entity identifier.

6. The method of claim 4, wherein querying the non-relational database utilises a sort key based on incrementing integer timestamps.

7. The method of claim 6, wherein the incrementing integer timestamps are Unix timestamps.

8. The method of claim 1, wherein the trained machine learning model comprises a representation of one or more computational graphs in a neural network exchange format.

9. The method of claim 1, wherein the trained machine learning model has been trained using a first machine learning framework, and wherein applying the trained machine learning model uses a second machine learning framework.

10. The method of claim 9, wherein a data storage size of the first machine learning framework is greater than a data storage size of the second machine learning framework.

11. The method of claim 9, wherein the first machine learning framework is a development machine learning framework and the second machine learning framework is a production machine learning framework.

12. The method of claim 1, wherein the contents of the package comprise a slimmed down machine learning framework, and applying the trained machine learning model uses the slimmed down machine learning framework.

13. The method of claim 11, wherein the slimmed down machine learning framework comprises a subset of a plurality of files of a full machine learning framework, wherein the subset excludes one or more of the plurality of files that are not accessed during one or more applications of the trained machine learning model using the full machine learning framework.

14. A data processing system comprising one or more processors configured to perform a method comprising:
loading the contents of a package comprising a computer program into an encapsulated execution environment, wherein a data storage size of the contents of the package is constrained from exceeding a package data storage size limit; and
executing, by one or more computing devices, the computer program in the encapsulated execution environment, wherein executing the computer program causes processing comprising:
obtaining, from a cloud storage service, a trained machine learning model, wherein a combined data storage size of the trained machine learning model and the contents of the package exceeds the package data storage size limit;
loading, in to temporary storage of the encapsulated execution environment, the trained machine learning model; and
applying the trained machine learning model to derive one or more vector outputs based on one or more vector inputs.

15. A non-transitory computer-readable storage medium having stored thereon a package comprising a computer program, wherein a data storage size of the contents of the package is constrained from exceeding a package data storage size limit, wherein the computer program comprises instructions which, when executed in an encapsulated execution environment by one or more computing devices, cause the one or more computing devices to carry out:
obtaining, from a cloud storage service, a trained machine learning model, wherein a combined data storage size of the trained machine learning model and the contents of the package exceeds the package data storage size limit;
loading, in to temporary storage of the encapsulated execution environment, the trained machine learning model; and
applying the trained machine learning model to derive one or more vector outputs based on one or more vector inputs.

16. (canceled)
